(19) United States
(12) Patent Application Publication
(10) Pub. No.: US 2018/0310655 A1
(43) Pub. Date: Nov. 1, 2018

(54) Light Emitting Helmet and Manufacturing Method Thereof

(71) Applicant: SHENZHEN QIANHAI LIVALL IOT TECHNOLOGY CO., LTD., Shenzhen, guangdong Province (CN)

(72) Inventor: Kenneth Liu, Shenzhen (CN)

(21) Appl. No.: 15/744,766

(22) PCT Filed: Feb. 4, 2016
(86) PCT No.: PCT/CN2016/073455

§ 371 Date: Jul. 16, 2018

(30) Foreign Application Priority Data
Jan. 9, 2016 (CN) 2016100109164

(51) Int. Cl. A42B 3/04; A42B 3/06; F21V 23/00; F21V 21/088; F21V 33/00; F21S 4/22

(52) U.S. Cl. CPC A42B 3/044; A42B 3/066; F21S 4/22; F21V 21/088; F21V 33/0008; F21V 23/002

(57) ABSTRACT

The present invention is applicable to the field of bicycle motion protection and safeguard equipment. The present invention discloses a light emitting helmet, including a helmet main body and a light emitting lamp band, a fixing groove is formed in the surface of the helmet main body, a through hole is formed in the fixing groove, the light emitting lamp band is provided with a control line, the light emitting lamp band is fixed in the fixing groove through a fixing mechanism, and when the light emitting lamp band is fixed, the control line is in signal connection with a controller by penetrating through the through hole. As the light emitting lamp band is fixed in the fixing groove, the control line of the light emitting lamp band forms the signal connection with the controller by penetrating through the through hole. Even if damage occurs, the light emitting lamp band can be singly repaired in the production process, thereby avoiding the problems that the light emitting lamp band arranged in the helmet main body cannot be repaired when a fault occurs, and that arrangement of the lead of the light emitting lamp band is complex in the forming process, and reducing the production cost and the forming difficulty of the light emitting helmet.

### FIELD OF THE INVENTION

The present invention relates to the technical field of bicycle motion protection and safeguard equipment, and in particular to a light emitting helmet and a manufacturing method thereof.

### BACKGROUND OF THE INVENTION

In order to protect the head, a helmet is required to withstand certain impact strength, and cannot be too heavy to affect the use at the same time, therefore the existing helmet generally includes an outer shell made of PC and an inner shell made of EPS and other lightweight materials.

Usually, for the needs of safety and entertainment, a light emitting lamp band is arranged on the helmet, such as an LED lamp band, an OLED lamp band or other electroluminescent lamp band, in order to play an alarm function on a rider or a motor vehicle even if the light is poor, and meanwhile light with different colors or lamp on forms can also be set to improve the entertainment.

In the existing light emitting helmet, the light emitting lamp band is arranged inside the helmet, namely, the light emitting lamp band is arranged between an inner layer and an outer layer, on one hand, the overall beauty of the helmet is increased, and on the other hand, the light emitting lamp band can be protected to a certain extent. However, when the light emitting helmet with such a structure is manufactured, the light emitting lamp band needs to be fixed in the inner layer, and then an inner layer material is injected to form the helmet, when the inner layer material is injected, 8 or so standard atmospheric pressures and a high temperature of 120-180 degrees Celsius are generated, the light emitting helmet is damaged easily and cannot be repaired, thereby increasing the production cost; and meanwhile, the light emitting helmet needs to be led out from the inside of the helmet in a forming process, thereby increasing the forming difficulty of the helmet.

### SUMMARY OF THE INVENTION

The main technical problem to be solved by the present invention is to provide a light emitting helmet and a manufacturing method thereof. The light emitting helmet can avoid the problems that a light emitting lamp band is damaged in a production process and cannot be repaired and that when the light emitting lamp band is formed in the helmet, arrangement of a lamp bar lead is complex, and the production cost and the forming difficulty of the light emitting helmet are reduced.

In order to solve the above technical problem, the present invention provides a light emitting helmet, including a helmet main body and a light emitting lamp band, a fixing groove provided with a through hole is formed in the surface of the helmet main body, the light emitting lamp band is provided with a control line, the light emitting lamp band is fixed in the fixing groove through a fixing mechanism, and when the light emitting lamp band is fixed, the control line is in signal connection with a controller by penetrating through the through hole.

Further, the fixing mechanism includes a matching component arranged on the light emitting lamp band and a fixing component arranged on the helmet main body and clamped with the matching component.

Further, the fixing component includes a fixing base provided with a clamping part, and the matching component includes a buckle in the shape of a snake butter head.

Further, the clamping part includes four clamping pieces, a gap is reserved between each two clamping pieces, and a clamping hole matched with the matching component is formed at junction end parts of the four clamping pieces.

Further, the fixing mechanism includes a male magic tape arranged on the helmet main body, a light emitting lamp band arranged on a female magic tape, and/or an adhesive layer arranged between the helmet main body and the light emitting lamp band.

Further, a conducting wire groove for accommodating conducting wires is formed in an inner side wall of the helmet main body, and the helmet main body groove communicates with the through hole.

Further, a step structure and a damping gasket matched with the step structure arranged on the inner side of the edge of the helmet main body.

Further, the helmet main body is further provided with a pre-embedded piece used for fixing the controller, a clamping part matched with the buckle on the controller is arranged on the pre-embedded piece, the clamping part includes at least two clamping pieces, a gap is reserved between each two clamping piece, a clamping holes matched with the buckle is formed at the end parts of the clamping pieces, and the clamping hole communicates with a storage cavity.

Further, the depth of the fixing groove is equivalent to the height of the light emitting lamp band.

The present invention further provides a light emitting helmet manufacturing method, including:

an outer shell forming step: carrying out blister forming on a PC sheet of an outer shell base material to form an outer shell with a groove, wherein an outer shell hole and a fixing hole are formed in the groove to from the outer shell;

a light emitting lamp band forming step: enabling a strip-shaped light emitting lamp coated with a transparent protection layer to be provided with a control line extending out from the protection layer to form a light emitting lamp band;

a helmet main body forming step: fixing the outer shell to an inner layer mold, injecting an inner layer material, and performing injection molding to form a helmet main body with a fixing groove, wherein the helmet main body is provided with a through hole communicating with the outer shell hole; and

a light emitting lamp band fixing step: forming a signal connection between a control line on the light emitting lamp band and a controller after the control line penetrates through the through hole, and fixing the light emitting lamp band in the fixing groove.

Further, the light emitting lamp band forming step further includes: arranging a buckling component on the light emitting lamp band, and pre-embedding a fixing component matched with the buckling component in the position of the fixing hole.

Further, the light emitting lamp band fixing step further includes: arranging an adhesive layer or male and female magic tapes between the light emitting lamp band and the bottom of the fixing groove.

Further, the helmet main body forming step further includes: forming a step structure provided with a conducting wire groove at a position on the inner side of the helmet main body close to the edge.

Further, the helmet main body forming step further includes: forming a conducting wire groove communicating with the through hole in the inner side of the helmet main body.

Further, the helmet main body forming step further includes: forming a step structure provided with a conducting wire groove at a position on the inner side of the helmet main body close to the edge, and arranging a damping gasket on the step structure.

The light emitting helmet of the present invention includes the helmet main body and the light emitting lamp band, the fixing groove is formed in the surface of the helmet main body, a hole is formed in the fixing groove, the light emitting lamp band is provided with the control line, the light emitting lamp band is fixed in the fixing groove through the fixing mechanism, and when the light emitting lamp band is fixed, the control line is in signal connection with the controller by penetrating through the through hole. As the light emitting lamp band is fixed in the fixing groove, the control line of the light emitting lamp band forms the signal connection with the controller by penetrating through the through hole. Even if damage occurs, the light emitting lamp band can be singly repaired in the production process, thereby avoiding the problems that when the light emitting lamp band arranged in the helmet main body can not be repaired after a fault occurs, and that arrangement of the lead of the light emitting lamp band is complex in the forming process, and reducing the production cost and the forming difficulty of the light emitting helmet.

### BRIEF DESCRIPTION OF THE DRAWINGS

To illustrate technical solutions in the embodiments of the present invention or in the prior art more clearly, a brief introduction on the accompanying drawings which are needed in the description of the embodiments or the prior art is given below. Apparently, the accompanying drawings in the description below are merely some of the embodiments of the present invention, based on which other accompanying drawings can be obtained by those of ordinary skill in the art without any creative effort.

FIG. 1 is a schematic diagram of a structure of an embodiment of a light emitting helmet.

FIG. 2 is a schematic diagram of a sectional structure of an embodiment of the light emitting helmet along a vertical direction of a light emitting lamp band.

FIG. 3 is a schematic diagram of a sectional structure of the light emitting lamp band along a length direction.

FIG. 4 is a schematic diagram of an overlooking structure of an embodiment of a fixing component.

FIG. 5 is a schematic diagram of a sectional structure of FIG. 4 along a B-B direction.

FIG. 6 is a schematic diagram of a sectional structure along a C-C direction.

FIG. 7 is a schematic diagram of a sectional structure when the light emitting lamp band is matched with the fixing component.

FIG. 8 is a schematic diagram of a step structure on a helmet main body.

FIG. 9 is a schematic diagram of a sectional structure of FIG. 8 along a D-D direction.

FIG. 10 is a schematic diagram of a sectional structure when a damping gasket is matched with the step structure after conducting wires are accommodated.

FIG. 11 is a flowchart of a light emitting helmet manufacturing method.

FIG. 12 is a schematic diagram of a sectional structure of an outer shell formed in an intermediate step of an outer shell forming step.

FIG. 13 is a sectional schematic diagram of an outer shell structure formed by the outer shell forming step.

FIG. 14 is a sectional schematic diagram of a structure formed by a light emitting lamp band forming step.

FIG. 15 is a sectional schematic diagram of the outer shell structure formed by a helmet main body forming step.

FIG. 16 is a sectional schematic diagram of a structure formed after the light emitting lamp band is fixed.

FIG. 17 is a sectional schematic diagram of another outer shell structure formed by the outer shell forming step.

The objective implementation, functional characteristics and advantages of the present invention will be further described below in combination with embodiments and with reference to the accompanying drawings.

### DETAILED DESCRIPTION OF THE EMBODIMENTS

In order that the objectives, technical solutions and advantages of the present invention are clearer, a clear and complete description of technical solutions in the embodiments of the present invention will be given below, in combination with the accompanying drawings in the embodiments of the present invention. Apparently, the embodiments described below are merely a part, but not all, of the embodiments of the present invention. All of other embodiments, obtained by those of ordinary skill in the art based on the embodiments of the present invention without any creative effort, fall into the protection scope of the present invention.

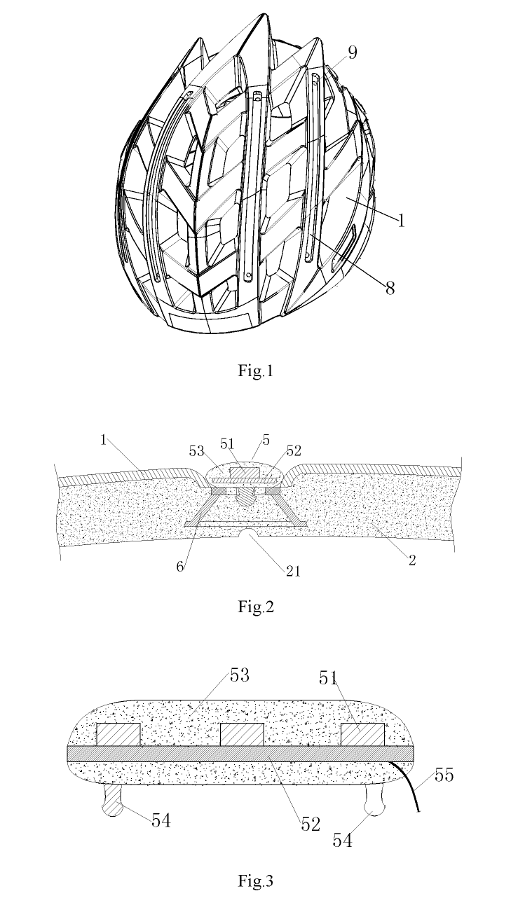

As shown in FIG. 1 to FIG. 3, the present invention provides an embodiment of a light emitting helmet.

The light emitting helmet includes a helmet main body and a light emitting lamp band 5, a fixing groove 8 is formed in the surface of the helmet main body, a through hole 9 is formed in the fixing groove 8, the light emitting lamp band 5 is provided with a control line 55, the light emitting lamp band 5 is fixed in the fixing groove 8 through a fixing mechanism, and when the light emitting lamp band 5 is fixed, the control line 55 is in signal connection with a controller by penetrating through the through hole 9.

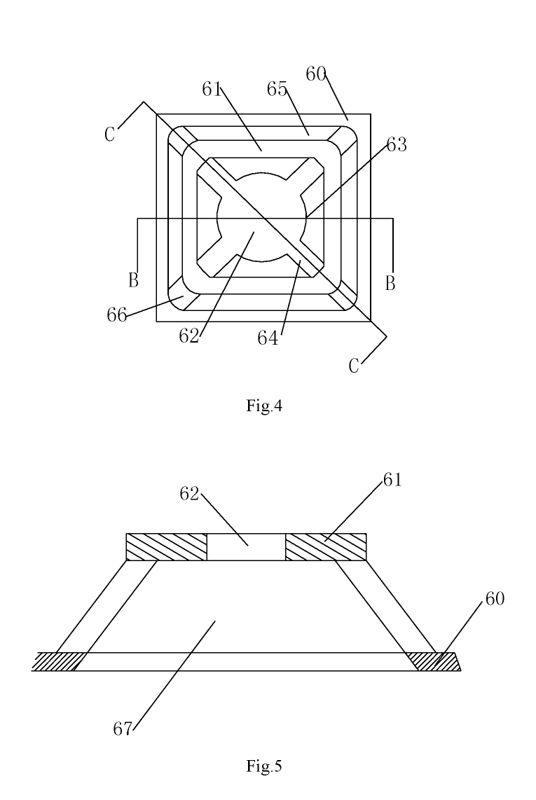

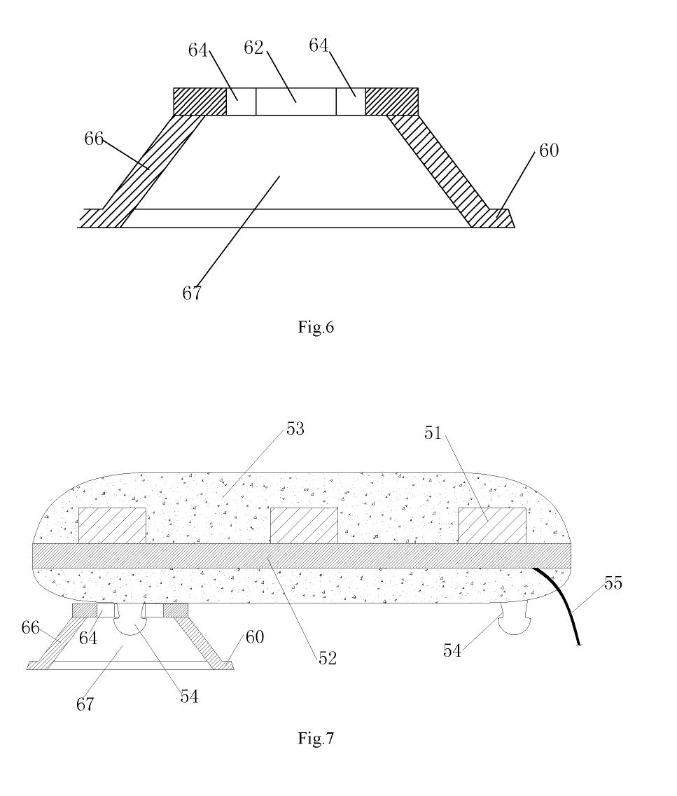

Specifically, the helmet main body includes an outer shell 1 and an inner layer 2, wherein the outer shell is generally made of a PC material, and the inner layer is made of an EPS material. The fixing mechanism includes a matching component arranged on the light emitting lamp band 5 and a fixing component 6 clamped with the matching component, the shape of the fixing component 6 is not specially limited, the fixing component includes a fixing base matched with the helmet main body, namely, the fixing base is pre-embedded in the helmet main body. A clamping part 61 is arranged on the fixing base, the matching component includes a buckle 54 in the shape of a snake butter head, the clamping part 61 includes at least two clamping pieces 60, a gap is reserved between each two clamping pieces 63, a clamping hole 62 matched with the buckle 54 is formed at the end parts of the clamping pieces 63, and the clamping hole 62 communicates with a storage cavity 60, as shown in FIG. 4 to FIG. 7. Usually, the fixing component 6 is made of a plastic material, therefore the clamping pieces 64 have certain elasticity. When the light emitting lamp band is fixed, the buckle 54 can extrude the clamping pieces 64 to generate deformation, and resets after clamping the clamping pieces in place so as to fix the light emitting lamp band 5.

As the inner layer constituting the helmet main body is usually made of the EPS material by injection molding, in order to tightly combine and fix the fixing component 6 with the inner layer EPS material, a wavy or dentate structure is arranged on a side face of the fixing component 6 to increase the contact stress area with the inner layer of the helmet main body. The side face of the fixing component 6 can be set as an inclined plane, and its function is the same as that of the wavy or dentate structure.

The light emitting lamp band 5 includes a circuit board 52 and a plurality of electric light sources 51 arranged on the same side of the circuit board 52, the circuit board 52 and the electric light sources 51 are coated with a transparent protection layer 53, the protection layer 53 is led out from the circuit board 52 by a conducting wire 55 to be connected with the controller, the buckle 54 matched with the fixing component 6 is further arranged on another light emission sides of the electric light sources 51, the buckle 54 can be of a mushroom structure, namely, one end is large, the middle part is small, the buckle 54 can also adopt other similar structures, as long as the matching and fixing with the fixing component 6 can be realized. The electric light sources 51 can protect the circuit board 52 and the electric light sources 51 through the protection layer 53, it is only required that the protection layer 53 is located on the light emission surfaces of the electric light sources 51 and made of a transparent material, but for the convenience of production, the light emission surfaces and the opposite surfaces of the light emission surfaces are made of the same material, such as silica gel or the like. The buckle 54 can be integrally formed with the protection layer 53, and separate parts can also be fixed with the protection layer 53 through adhesion.

In order to ensure a wide light emission range of the light emitting lamp band 5, the depth of the fixing groove 8 can be slightly smaller than the thickness of the light emitting lamp band 5, namely the light emitting lamp band 5 is slightly higher than the surface of the helmet. But in order to protect the light emitting lamp band 5 to reduce collision possibility in the use process, the depth of the fixing groove 8 is equivalent to the height of the light emitting lamp band 5.

As the helmet main body and the light emitting lamp band 5 adopt a separate structure, namely are separately produced and then are assembled and fixed, even if the helmet main body is faulty in a production process or is damaged in the use process, the light emitting lamp band or the helmet main body can be singly repaired, thereby avoiding the problem that the light emitting lamp band 5 arranged in the helmet main body cannot be repaired when a fault occurs, resulting in increase of the production cost. Meanwhile, when the helmet main body is formed, arrangement of the lead with the pre-embedded light emitting lamp band is complex, the forming difficulty of the light emitting helmet can be reduced, and the production efficiency is improved.

The fixing component 6 can also adopt the following structure:

At least two clamping pieces 61 are arranged on one end of the fixing component 6, a gap 63 is reserved between each two clamping pieces 61, a clamping hole 62 matched with the buckle is formed at the end parts of the clamping pieces 61, a cavity structure 65 is arranged on the other end of each clamping piece, the clamping hole 62 communicates with the cavity structure 65, and a wavy or dentate structure is arranged on the side face of the fixing component 6. When in use, the inner layer 2 of the helmet main body is usually made of the EPS material, when the fixing component 6 is combined with the inner layer 2, even if the cavity structure 65 is filled with the EPS material, as the EPS material has certain compressional deformation property, the buckle 54 can be matched with the fixing component 6 to realize fixing. The fixing component 6 having the structure can be fixed with the light emitting lamp band 5 and is unlikely to separate from the helmet main body by a small volume and material. An adhesive can also be arranged between the light emitting lamp band 5 and the helmet main body according to needs, so that the light emitting lamp band is fixed more firmly. The fixing mechanism can also adopt male and female magic tapes and/or and an adhesive layer.

In order that conducting wires 3 used for connecting the electric light sources 51 with the controller 7 can be accommodated and fixed, a conducting wire groove 21 can be formed in the inner side of the helmet main body, and the conducting wire groove 21 communicates with the through hole 9. A limiting component can be arranged in the conducting wire groove 21 according to needs, therefore the conducting wires 55 can be better fixed, wherein the limiting component can be implemented with the existing structure.

The helmet main body is further provided with a pre-embedded piece used for fixing the controller 7 according to needs, the pre-embedded piece is provided with a fixing component matched with the buckle on the controller, and the fixing component and the buckle are implemented by adopting the structure in the above embodiment. The detachability between the controller and the helmet main body can be realized, and even if the controller is damaged, only the controller 7 needs to be replaced, thus the maintenance convenience is improved.

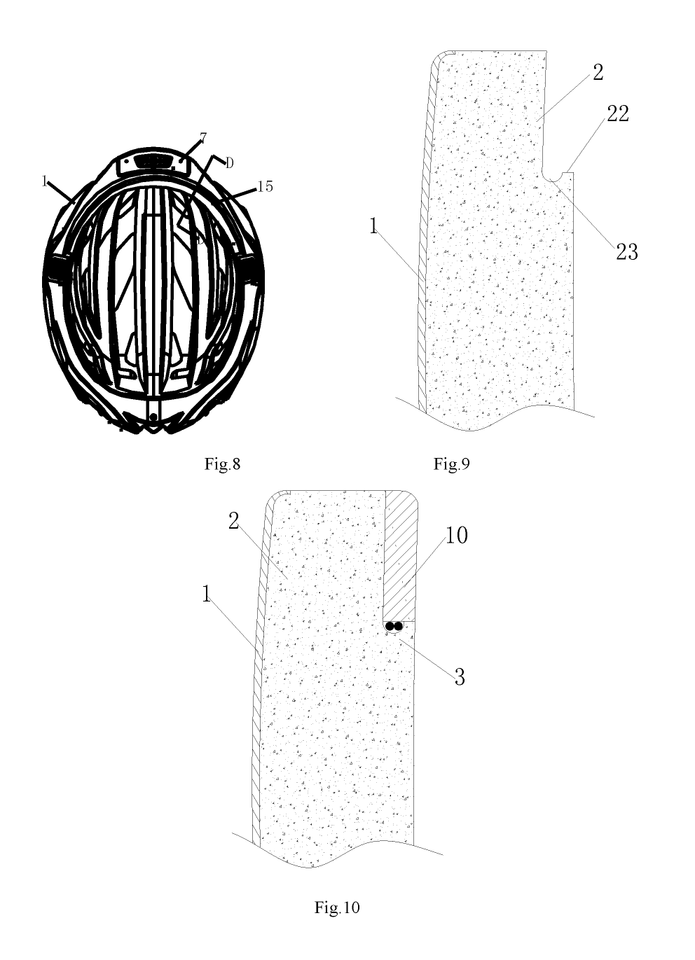

As shown in FIG. 8 to FIG. 10, another conducting wire fixing structure is further provided, that is, a step structure 22 and a damping gasket 10 matched with the step structure 22 are arranged on the inner side of the edge of the helmet main body, and a conducting wire groove 23 for accommodating the conducting wires is formed in the step structure 22. When in use, the conducting wires 3 connected with the controller are connected with the control line 55 on the light emitting lamp band 5, the conducting wires 3 are located in the conducting wire groove 23, and the damping gasket 10 is fixed on the step structure 22 through magic tapes and in other manners. On one hand, the damping gasket 10 can protect and fix the conducting wires 3 to avoid exposure of the conducting wires. On the other hand, the damping gasket 10 is in contact with the head, the damping gasket 10 made of a flexible or elastic material can absorb impact energy for the second time after the helmet main body absorbs the impact energy for the first time, so as to further protect the head in the case of collision. The damping gasket 10 and the helmet main body adopt a fast detachment structure, such as the magic tapes and the like, thereby facilitating the wiring of the conducting wires 3.

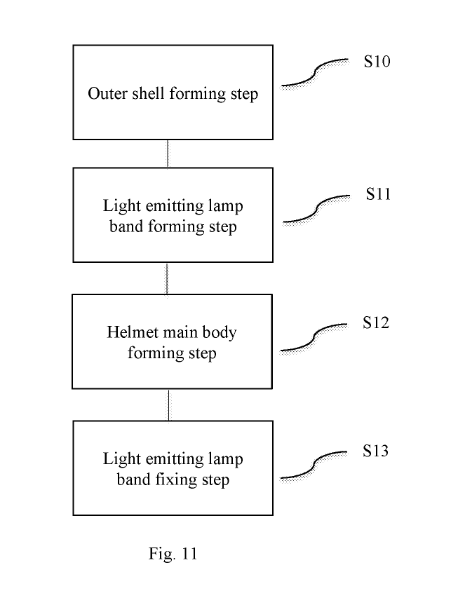

As shown in FIG. 11, the present invention further provides a light emitting helmet manufacturing method. The light emitting helmet manufacturing method includes:

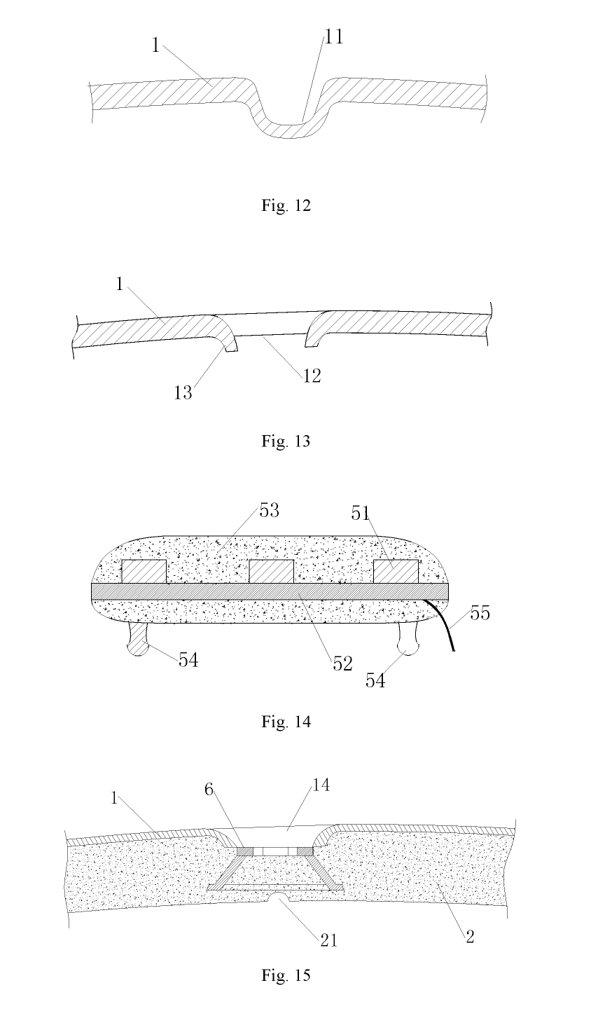

Step S10, an outer shell forming step: carrying out blister forming on a PC sheet of an outer shell base material to form an outer shell with a groove 11, as shown in FIG. 12, wherein cutting is performed at a proper position of the side wall of the groove 11 to form a strip-shaped hole 12, namely the side wall of the groove 11 is cut to form an extension part formed by reserving part of the side wall of the groove so as to form an outer shell, the extension part can protect the EPS material of the inner layer so as to prevent the exposed EPS material of the inner layer from being broken by stress to affect the safety;

step S11, a light emitting lamp band forming step: coating a transparent protection layer 53 on a strip-shaped light emitting lamp band, arranging a buckle 54 on the protection layer 53, and extending a control line 55 of the light emitting lamp out from the protection layer 53 to form a light emitting lamp band 5, as shown in FIG. 14, wherein the buckle 54 has the snake butter head structure as shown in the above embodiment, the buckle 54 and the protection layer 53 can be integrally formed, or can employ separated structures, namely the protection layer 53 and the buckle 54 are separately manufactured, and then the buckle 54 is fixed to the protection layer 53 by glue and the like;

step S12, a helmet main body forming step: fixing the outer shell, a fixing component used for fixing the light emitting lamp band and a controller pre-embedded piece to an inner layer mold, injecting an inner layer material, and performing injection molding to form a helmet main body, wherein a fixing groove matched with the light emitting lamp band is formed in a position corresponding to the strip-shaped hole of the outer layer, as shown in FIG. 15, and a through hole 6 is formed in the fixing groove, as shown in FIG. 1; the fixing component adopts the structure in the above embodiment, namely, the fixing component is matched with the structure of the buckle 54 in step S11 to realize clamping and fixing, the specific fixing component is not specially limited, the fixing component can include a fixing base matched with the helmet main body, a clamping part is arranged on the fixing base, the clamping part 61 includes at least two clamping pieces 60, a gap 63 is reserved between each two clamping pieces 64, a clamping hole 62 matched with the buckle 54 is formed at the end parts of the clamping pieces 63, and the clamping hole 62 communicates with a storage cavity 60, as shown in FIG. 4 to FIG. 7. Usually, the fixing component 6 is made of a plastic material, therefore the clamping pieces 64 have certain elasticity, when the light emitting lamp band is fixed, the buckle 54 can extrude the clamping pieces 64 to generate deformation, and resets after clamping the clamping pieces in place so as to fix the light emitting lamp band 5; and

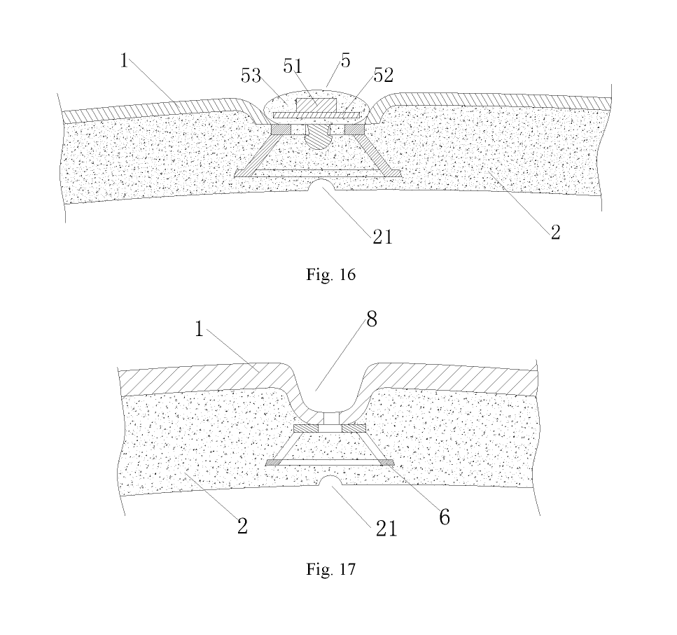

step S13, a light emitting lamp band fixing step: forming a signal connection between the control line 55 on the light emitting lamp band in step S11 and the controller 7 after the control line penetrates through the through hole 6, and fixing the light emitting lamp band in the fixing groove, namely, matching the buckle 54 on the light emitting lamp band 5 with the fixing component on the helmet main body for fixing, as shown in FIG. 16, wherein an adhesive can also be arranged between the light emitting lamp band 5 and the helmet main body according to needs, so that the light emitting lamp band is fixed more firmly.

As the helmet main body and the light emitting lamp band are separately manufactured, the light emitting lamp band or the helmet main body can be singly repaired even if being damaged in the production process, thereby avoiding the problems that the light emitting lamp band arranged in the helmet main body cannot be repaired when a fault occurs, and that arrangement of the lead of the light emitting lamp band is complex in the forming process, and reducing the production cost and the forming difficulty of the helmet.

In the embodiment, the structure as shown in FIG. 17 can be formed in the outer shell forming step S10, specifically, blister forming is carried out on the PC sheet of the outer shell base material to form the outer shell with the groove, an outer shell hole and a fixing hole are formed in the groove to from the outer shell, that is, a hole is formed in the bottom of the groove 11 when the outer shell is formed, and the side wall of the groove 11 is not cut to form the strip-shaped hole 12 of the extension part 13 formed by reserving part of the side wall of the groove. In the helmet main body forming step S12, the outer shell is fixed to the inner layer mold, the inner layer material is injected, injection molding is carried out to form the helmet main body with the fixing groove, the helmet main body is provided with a through hole communicating with the outer shell hole, the helmet main body with the fixing groove 8 is formed. Other structures and steps are the same as those in the above embodiment, and the above objectives can also be achieved.

In the embodiment, the helmet main body forming step further includes: forming a step structure 22 provided with a conducting wire groove 23 at a position on the inner side of the helmet main body close to the edge, as shown in FIG. 9. After the light emitting lamp band 5 is fixed, the control line 55 is accommodated in the conducting wire groove 23, then the damping gasket 10 is fixed on the step structure 22 through magic tapes to protect the control line 55 and contact the head of a user at the same time, the damping gasket 10 made of the flexible or elastic material can absorb impact energy for the second time after the helmet main body absorbs the impact energy for the first time in the case of collision, so as to further protect the head.

According to needs, the helmet main body forming step further includes: forming a conducting wire groove 21 communicating with the through hole in the inner side of the helmet main body, and the control line 55 can be accommodated in the conducting wire groove 21. The light emitting lamp band fixing step further includes: arranging an adhesive layer or male and female magic tapes between the light emitting lamp band and the bottom of the fixing groove.

The above-mentioned embodiments are merely used for illustrating, instead of limiting the technical solutions of the present invention. Although the present invention has been described in detail with reference to the foregoing embodiments, those of ordinary skill in the art should understand that they could still make modifications to the technical solutions recorded in the foregoing embodiments or make equivalent substitutions to a part of technical features, and these modifications or substitutions do not make the essence of the corresponding technical solutions depart from the spirit or scope of the technical solutions of the embodiments of the present invention.

1. A light emitting helmet, comprising a helmet main body and a light emitting lamp band, wherein a fixing groove provided with a through hole is formed in the surface of the helmet main body, the light emitting lamp band is provided with a control line, the light emitting lamp band is fixed in the fixing groove through a fixing mechanism, and when the light emitting lamp band is fixed, the control line is in signal connection with a controller by penetrating through the through hole.

2. The light emitting helmet of claim 1, wherein the fixing mechanism comprises a matching component arranged on the light emitting lamp band and a fixing component arranged on the helmet main body and clamped with the matching component.

3. The light emitting helmet of claim 2, wherein the fixing component comprises a fixing base provided with a clamping part, and the matching component comprises a buckle in the shape of a snake butter head.

4. The light emitting helmet of claim 3, wherein the clamping part comprises four clamping pieces, a gap is reserved between each two clamping pieces, and a clamping hole matched with the matching component is formed at junction end parts of the four clamping pieces.

5. The light emitting helmet of claim 1, wherein the fixing mechanism comprises a male magic tape arranged on the helmet main body, a light emitting lamp band arranged on a female magic tape arranged on, and/or an adhesive layer arranged between the helmet main body and the light emitting lamp band.

6. The light emitting helmet of claim 1, wherein a step structure and a damping gasket matched with the step structure are arranged on the inner side of the edge of the helmet main body, and a conducting wire groove for accommodating conducting wires is formed in the step structure.

7. A light emitting helmet manufacturing method, comprising:
an outer shell forming step: carrying out blister forming on a PC sheet of an outer shell base material to form an outer shell with a groove, wherein an outer shell hole and a fixing hole are formed in the groove to from the outer shell;
a light emitting lamp band forming step: enabling a strip-shaped light emitting lamp coated with a transparent protection layer to be provided with a control line extending out from the protection layer to form a light emitting lamp band;
a helmet main body forming step: fixing the outer shell to an inner layer mold, injecting an inner layer material, and performing injection molding to form a helmet main body with a fixing groove, wherein the helmet main body is provided with a through hole communicating with the outer shell hole; and
a light emitting lamp band fixing step: forming a signal connection between a control line on the light emitting lamp band and a controller after the control line penetrates through the through hole, and fixing the light emitting lamp band in the fixing groove.

8. The light emitting helmet manufacturing method of claim 7, wherein the light emitting lamp band forming step further comprises: arranging a buckling component on the light emitting lamp band, and pre-embedding a fixing component matched with the buckling component in the position of the fixing hole.

9. The light emitting helmet manufacturing method of claim 7, wherein the light emitting lamp band fixing step further comprises: arranging an adhesive layer or male and female magic tapes between the light emitting lamp band and the bottom of the fixing groove.

10. The light emitting helmet manufacturing method of claim 7, wherein the helmet main body forming step further comprises: forming a step structure provided with a conducting wire groove at a position on the inner side of the helmet main body close to the edge, and arranging a damping gasket on the step structure.
